(19) United States
(12) Patent Application Publication
(10) Pub. No.: US 2011/0231159 A1
(43) Pub. Date: Sep. 22, 2011

(54) FORWARDING OPERATION DATA RELATED TO THE PRESENT OPERATION OF A PLURALITY OF INVERTER UNITS TO A MONITORING UNIT

(75) Inventors: Claus Allert, Kaufungen (DE); Maurice Gonska, Kassel (DE); Lothar Kurt Mueller, Kassel (DE); Joern Tuemmler, Habichtswald (DE); Bjoern Magnussen, Kassel (DE)

(73) Assignee: SMA Solar Technology AG, Niestetal (DE)

(21) Appl. No.: 13/112,069

(22) Filed: May 20, 2011

Related U.S. Application Data
(63) Continuation of application No. PCT/EP2009/065667, filed on Nov. 23, 2009.

(30) Foreign Application Priority Data
Nov. 21, 2008 (EP) 08020270.8

(51) Int. Cl. G06F 15/00

(52) U.S. Cl. 702/188

(57) ABSTRACT

For forwarding operation data related to the present operation of a plurality of inverter units which feed electric power from power generators into a power grid to a monitoring unit, the inverter units and a plurality of intermediate data handling units are connected to the central monitoring unit in a communication network of logical tree architecture. The tree architecture branches towards the inverter units, and several inverter units are connected to each intermediate unit. The operation data from each inverter unit are forwarded to that intermediate unit to which the inverter unit is connected; and, in each intermediate unit connected between the inverter units from which the operation data are forwarded and the monitoring unit, operation data of the same type forwarded from the inverter units connected to the intermediate unit are merged to reduce their data volume, and only the merged operation data are forwarded towards the monitoring unit.

### REFERENCE TO RELATED APPLICATIONS

This application is a continuation of International Application PCT/EP2009/065667, entitled, “Forwarding Operation Data Related to the Present Operation of a Plurality of Inverter Units to a Monitoring Unit,” filed Nov. 23, 2009, which claims priority to European Patent Application No. 08 020 270.8, filed Nov. 21, 2008.

### FIELD

The present invention relates to a method of forwarding operation data related to the present operation of a plurality of inverter units to a monitoring unit, the inverter units feeding electric power from power generators into a power grid. Further, the present invention relates to a data handling unit suitable for use in the method of the invention. Even further, the present invention relates to a data protocol suitable for requesting and forwarding operation data related to the present operation of a plurality of inverter units by and to a monitoring unit, the inverter units feeding electric power from power generators into a power grid.

The power generators may be photovoltaic power generators, wind power generators, combined heat and power (CHP) stations and/or water power generators, for example. The power generators may either be all of one kind of power generator or a mixture of different kinds of power generators. Even in the latter case, however, the power generators connected to one of the plurality of inverters will often all be of the same kind of power generators.

Each of the plurality of inverter units is able to provide a plurality of operation data related to the present operation of the respective inverter unit. These operation data available from the inverter units may also include operation data related to the present operation of the power generators connected to the inverter units.

The inverter units feed electric power from the power generators into a power grid. This power grid may be a public power grid or an isolated power grid. It may also only be the power supply of a single electric load. Generally, the power grid will be an AC power grid. In principle, however, it may also be a DC power grid.

### BACKGROUND

WO 2008/138288 A1 discloses a method and a data handling unit. Here, groups of several inverter units are each linked as slaves to one inverter unit being a master and forwarding operation data received from the slaves via a further data link to central communication units, data loggers or control units. In the opposite direction, control commands are forwarded to the single inverter units. The intention of this monitoring and control structure is to have one global power station in which the values of the power fed into the power grid can be centrally controlled via the control units.

WO 2008/138288 A1 points out that the links between the slave inverters and the master inverter as well as the data link between the master inverter and the control and monitoring units may be based on different techniques like for example ISM broadcasting, Bluetooth, WLAN, ZigBee, Z-Wave, NanoNet, EnOcean, which are all wireless techniques, and RS 485, Ethernet, CAN Technology, which are cable-based technologies.

However, even the latest data link technologies only provide for limited data transfer rates, particularly, if the data transfer has to be absolutely reliable and has to take place over longer distances. These limited data transfer rates cause problems with an increased number of slave inverters connected to each master inverter as the data volume to be transferred via the data link of the master inverter to the control and monitoring units increases with this number of inverters and also with the number of power generators connected to each inverter. Particularly, if the inverters are to be controlled based on operation data measured with a high sample rate and by control signals which may also change at a high frequency, the total data volume to be passed over one data link may soon become enormous and too large for the existing data link.

Further, with an increasing number of inverters, it becomes more and more sophisticated for the control and monitoring units to forward requests for operation data to the single inverter units and to handle the operation data retrieved by these requests.

Thus, there still is a need for a method of forwarding operation data related to a plurality of inverter units to a monitoring unit, a data handling unit suitable for use in this method, and a data protocol, which allow for easily transferring the operation data of an increasing number of inverters via data links with limited data transfer rates.

### SUMMARY

In an aspect, the present invention provides a method of forwarding operation data related to the present operation of a plurality of inverter units to a monitoring unit, the inverter units feeding electric power from power generators into a power grid. The method comprises connecting the inverter units and a plurality of intermediate data handling units to the central monitoring unit in a communication network of logical tree architecture, the tree architecture branching towards the inverter units, and several inverter units being connected to each intermediate unit; and forwarding the operation data from each inverter unit to that intermediate unit to which the inverter unit is connected. The method further comprises, in each intermediate unit connected between the inverter units from which the operation data are forwarded and the monitoring unit, merging operation data of the same type forwarded from the inverter units connected to the intermediate unit to reduce their data volume; and from each intermediate unit towards the monitoring unit, forwarding the merged operation data only.

In a further aspect, the present invention provides a data handling unit suitable for forwarding operation data related to the present operation of a plurality of inverter units to a monitoring unit, the data handling unit comprising an upward connection port for receiving requests for values from an upper unit and for forwarding the requested operation data to the upper unit. The data handling unit further comprises a downward connection port for sending requests for values to a plurality of lower units and for receiving the requested operation data from the lower units, wherein the data handling unit, upon receiving a generic request from the upper unit which does not request operation data available in the data handling unit, forwards the request to all of the plurality of lower units, merges the operation data received in return to that request from the lower units to reduce their data volume, and only forwards the merged operation data to the upper unit.

In a further aspect, the present invention provides a data protocol suitable for requesting and forwarding operation data related to the present operation of a plurality of inverter units by and to a monitoring unit, the inverter units feeding electric power from power generators into a power grid. The data protocol comprises a generic request issued by the monitoring unit, the generic request being coded in a key code having a plurality of coding ranges each defining one aspect of the operation data in variable detail depending on the actual setting of the key code in the respective coding range, and the generic request indicating that every unit which is able to forward the requested operation data should do so. Further, the data protocol comprises operation data forwarded by the inverter units in response to a generic request, the operation data having a format enabling to merge operation data of the same type included in the operation data forwarded by the multitude of inverter units without changing the format.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention will be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a basic design of a communication network in a power generating installation.

FIG. 2 indicates an embodiment of a first step of forwarding operation data via the communication network of FIG. 1.

FIG. 3 indicates an embodiment of a step of merging operation data forwarded via the communication network according to FIG. 2.

FIG. 4 indicates a further embodiment of a first step of forwarding operation data via the communication network of FIG. 1; and

FIG. 5 indicates an embodiment of a step of merging operation data forwarded via the communication network according to FIG. 2.

### DETAILED DESCRIPTION

In the method of forwarding operation data related to the present operation of a plurality of inverter units to a monitoring unit, where the inverter units feed electric power from power generators into a power grid, the inverter units and a plurality of intermediate data handling units are connected to a central monitoring unit in a communication network of logical tree architecture. This tree architecture branches towards the inverter units, and several inverter units being connected to each intermediate unit. However, it is not essential that the tree architecture branches at each intermediate unit. There may be intermediate units only connected to one further intermediate unit or inverter in the direction towards the inverter units. Within this communication network, the operation data related to the present operation of the inverter units are forwarded from each inverter unit to that intermediate unit to which the inverter unit is connected. In the novel method of forwarding present operation data, the intermediate unit receiving the operation data does not simply forward these data in the direction towards the monitoring unit. Instead, in each intermediate unit, connected between the inverter units from which the operation data are forwarded, and the monitoring unit, operation data of the same type are merged to reduce their data volume, and only the merged operation data are forwarded towards the monitoring unit. Thus, the overall data volume is continuously reduced towards the monitoring unit, i.e. in parallel to the decrease in the number of branches of the logical tree architecture towards the monitoring unit. As a result, the data links close to the monitoring unit do not have to handle an essentially higher data volume than the data links between the units closer to the inverters. This clearly enhances the overall communication speed. In most cases, the multitude of operation data originally provided by the plurality of inverter units has to be condensed for analysis and interpretation anyway. By merging operation data of the same kind, at least a part of the necessary condensing procedures are outsourced to the intermediate units, and details of information which are completely irrelevant in the present application are suppressed at an early stage. An owner of a power plant or a surveillance technician interested in an overview of the present operation of the plurality of inverter units, for example, will not be interested in every single detail of the original operation data of every single inverter unit, but in operation data easy to interpret. Thus, the steps of merging operation data of the same type within each intermediate unit may be regarded as a pre-evaluation of the operation data within the intermediate units, particularly including those partial steps of the evaluation which reduce the data volume of the operation data. However, it is not necessary to provide substantial data processing power in the intermediate units, as the steps of merging operation data in the intermediate units may be kept very simple. Even with different types of operation data, the step of merging may only have a limited number of simple variants as will be described below.

The described method of forwarding present operation data will have particular advantages, if the inverter units from which the operation data are forwarded are spatially distributed so that at least one data link between two units of the communication network has a substantial spatial extension potentially delimiting its data transfer rate. To the end of reducing the number of data links of the communication network having to cover long distances between the connected units, it may be advantageous to arrange the intermediate units spatially closer to the inverter units than to the monitoring units. With regard to the overall spatial extension of the communication network, this means an early reduction of the data volume by means of merging the operation data.

As already pointed out, the step of merging the operation data in each intermediate unit may be kept very simple. In the following, this statement will be underlined by indicating the typical pieces of information included in the merged operation data. Of course, it is not necessary that all the pieces of information listed below will be provided with every operation data. Instead, the pieces of information contained in the actual merged operation data will depend on the type of operation data merged and all such variations are contemplated by the present invention.

Typical pieces of information included in the merged operation data are selected from a group having the following members, for example:
a number of the inverter units from which the operation data contributing to the merged operation data have been forwarded;
an overall range of values of the same type included in the operation data contributing to the merged operation data;
an average of values of the same type included in the operation data contributing to the merged operation data;
a standard deviation of values of the same type included in the operation data contributing to the merged operation data from their average;
a median of values of the same type included in the operation data contributing to the merged operation data;
a sum total of values of the same type included in the operation data contributing to the merged operation data;
a number of identical discrete values of the same type included in the operation data contributing to the merged operation data;
a code indicating the type of the operation data contributing to the merged operation data; and
the kind of the inverter units from which the operation data contributing to the merged operation data have been forwarded.

The number of inverter units from which the operation data contributing to the merged operation data have been forwarded is a measure of the weight of the merged operation data. This weight should be considered when further merging the merged operation data in a next intermediate unit towards the monitoring unit, when calculating averages of values, for example.

The overall range of values of the same type included in the operation data is indicative of the spread of these values. If the overall range of a particular kind of values includes one or more values of zero indicative of a kind of an error state of the unit providing this value, these values of zero may be purposefully excluded from the range of values included in the merged operation data and indicated separately, as the lowest value different from zero may be an additional information of interest.

An average of values of the same type often is the most interesting condensed information provided in merging the operation data from the inverter units. The standard deviation of the values from this average is another indication of the spread of these values. A calculation of a standard deviation, however, may require more data calculating power in the intermediate units.

A median of the values of the same type is another interesting piece of information, particularly if provided together with an average of the values and if deviating from this average. However, there is no simple mathematical operation to calculate the median of the original operation data based on the medians of already merged operation data, even if these merged operation data include further pieces of information of the above group.

In quite a few instances, the sum total of values of the same type included in the operation data contributing to the merged operation data may be of high interest, like for example when evaluating the overall output power of the inverter units into the power grid.

In other instances, a number of identical discrete values of the same type may be of high interest in the merged operation data. Such discrete values may simply be indicative of whether an inverter unit is operating or not. Thus, one piece of information in the merged data may indicate the number of inverter units from which the operation data originate being in an error state. In this case, the discrete values may also be called status values.

Most particularly, the merged data may include a code indicating the type of the operation data. This code may be used in the intermediate units to decide which operation data are to be merged. The code may also indicate the particularly rules for the merger, i.e. which pieces of information are to be provided in the merged operation data.

It has to be understood that the intermediate unit executing the step of merging the received operation data does not need to know the actual meaning of the operation data handled. It simply has to check whether the operation data are of the same type, and to select the rules for merging these operation data according to their type. Typically, there will be different types of operation data having totally different meanings with regard to the actual operation of the inverter units but which will nevertheless be merged according to the same rules.

The merged operation data may also include an indication of the kind of the inverter units from which the operation data contributing to the merged operation data have been forwarded. Generally, it may be advantageous to keep the operation data from different kinds of inverter units separately, i.e. not to merge them. If they are merged nevertheless, it is a piece of information of interest how many inverter units of which kind contributed to the merged operation data.

In a particular embodiment of the new method, the operation data received by each intermediate unit have a same format as the merged operation data. I.e. the intermediate units do not change the format of the operation data upon merging them. To this end, it is preferred that the original operation data forwarded from the inverter units already have that same format, although this may result in an increase of data volume forwarded from the inverter units to the intermediate units as compared to the actual information included in the operation data. This disadvantage, however, often proves to be small as compared to the advantage of all intermediate units operating exactly the same way independently of whether they are directly connected to the inverter units or to other intermediate units in the direction towards the inverter units.

The new method described supra reduces the data volume in the direction from the inverter units towards the monitoring unit. In the opposite direction, the data volume may be reduced in that forwarding the operation data towards the central unit is initiated by a single generic request issued by the monitoring unit and indicating that every unit in the communication network which is able to forward the requested operation data should do so. This generic request will only be issued once by the monitoring unit to each intermediate unit directly linked to it, and the generic request will simply be handled through towards the inverter units by all intermediate units which are not able to provide the requested operation data itself. As a result, the data volume of the request will be multiplied by the branches of the communication network extending from the intermediate unit towards the inverter units, but each branch or data link only has to forward the same data volume as the data links via which the request was originally transferred from the monitoring unit to the intermediate units directly connected to it. The advantage is that these data links which are a kind of bottleneck in the communication of the monitoring unit with the inverter units are each stressed with the single generic request only instead of separate requests directed to each of the inverter units connected to them. This single generic request is distributed over the whole tree architecture of the communication network at a substantially constant data transfer rate in each branch of the tree architecture. The operation data received in response to the generic request which are transferred via the communication network in the opposite direction towards the monitoring unit are merged to also achieve a substantially constant data transfer rate in each branch of the logical tree architecture to avoid a bottleneck effect towards the monitoring unit.

As an alternative to a generic request issued by the monitoring unit, the operation data may also be regularly forwarded from one unit to the next unit in the communication network towards the monitoring unit due a subscription of the operation data by that next unit. The subscription may of course be limited to one or more particular types of operation data. A subscription, for example, allows to keep a continuous record of operation data of interest over the operation time of the overall system.

In the new method, the communication network may terminate at the inverter units. However, it may also be extended to the power generators connected to the inverter units, or the inverter units may, by separate communication links, also receive operation data from the power generators. If the communication network is extended to the power generators, operation data from the power generators, upon being forwarded towards the monitoring unit, may be merged in the inverter units and any intermediate unit.

In the new method, further units in addition to the monitoring unit, the intermediate units, the inverter units and the power generators may be part of the communication network. Thus, the new method may comprise the further step of connecting at least one further unit to the communication network. The further unit may, for example, be a temperature sensor, a wind sensor or any other kind of sensor. Particularly, a plurality of various sensors and other further units may be connected to the communication network. The further unit may also be a further monitoring unit. Particularly, such a further monitoring unit may be a laptop or any other mobile monitoring unit via which a service technician requests operation data from the inverter units or any other units in the communication network. Another further unit may provide a communication interface via which a remote unit may communicate with all units connected to the communication network.

The new method also allows for easily connecting new units to an existing communication network. Independently on whether the new unit connected to the communication network is an intermediate unit, an inverter unit, a power generator or another kind of unit, it does not even need to be known to the monitoring unit to be addressed by the monitoring unit via a generic request. The only condition is that the new unit has to comply with the communication protocol used in the communication network. The new unit may, however, easily be made known to the monitoring unit in that the monitoring unit issues a generic request requesting an individual identification from each unit of a particular kind or even from every unit connected to the communication network.

The generic request which may be used to request the operation data from the inverter units in the new method may particularly be coded in a key code having a plurality of coding ranges. Each coding range of this key code may be used to define one aspect of the operation data to be forwarded by the inverter units in variable detail depending on the actual setting of the key code in the respective coding range. One of these coding ranges may for example be used to define the kind of inverter units from which the operation data are requested. Another coding range may define the particular physical values or measurement values to be included in the operation data.

Additionally, the key code may include an indication of the importance of the coded request. Different importances of different requests may be used to decide on which request has to be responded to first. Requests of equal importance will generally be responded to on a first come first served basis.

The key code which may be used for the generic request may also have at least one setting resulting in operation data being forwarded towards the monitoring unit without being merged in any intermediate unit. Thus, requests coded in the key code may also be used to request particular operation data from one single inverter unit. The request may also define a particular group of the inverter units to provide operation data which will only be merged over this particular group.

In one embodiment, one of the inverter units may be a master to other inverter units acting as slaves to the master. This may be achieved in that at least one intermediate unit is spatially arranged as one of the plurality of inverter units becoming the master.

A data handling unit suitable as an intermediate unit in the method of the present invention comprising an upward connection port for receiving request for values from an upper unit and for forwarding the requested operation data to the upper unit, and a downward connection port for sending request for values to a plurality of lower units and for receiving the requested operation data from the lower units is characterized in that upon receiving a generic request from the upper unit which does not request operation data available in the data unit, the data handling unit forwards the request to all of the plurality of lower units. When receiving operation data in return to that request from the lower units, the data handling unit merges these operation data to reduce their volume, and only forwards the merged operation data to the upper unit. As already indicated above, this function of the data handling unit may be implemented with little data calculation power in the data handling unit, and particularly without any knowledge of the data handling unit about the actual meaning or content of the merged operation data.

In one embodiment, the data handling unit does not change the format of the operation data while merging the operation data. Thus, the merged operation data forwarded by the data handling unit have a same format as the received operation data.

The data protocol according to the present invention is particularly well suited for requesting and forwarding operation data related to the present operation of a plurality of inverter units by and to a monitoring unit, the inverter units feeding electric power from power generators into a power grid. To this end, the novel data protocol comprises a generic request issued by the monitoring unit, the generic request being coded in a key code having a plurality of coding ranges each defining one aspect of the operation data in variable detail depending on the actual setting of the key code in the respective coding range, and the generic request indicating that every unit which is able to forward the requested operation data should do so. In addition, in one embodiment the operation data forwarded by the inverter units in response to a generic request, has a format enabling a merge of operation data of the same type included in the operation data forwarded by the multitude of inverter units without changing the format.

The key code defines the operation data of the same type to be merged when merging the operation data, and the rules according to which the merger is to be executed.

In one embodiment the key code may have at least three different coding ranges, for example defining a level of importance of the requested operation data, a general kind of the requested operation data, and a kind of the units from which the operation data are requested, in variable detail. These ranges may be subdivided further. For example, the general kind of the requested operation data may be subdivided in a kind of area of a power plant from which the operation data are requested and in a kind of physical meaning of the requested operation data. The variable detail of the settings in the key code ranges may each include settings corresponding to no selection, a limited or partial selection, and a full selection or a selection of a single kind to place different restrictions on the requested operation data.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

Power generating installations having a plurality of electricity or power generators and inverter units converting the DC power provided by the power generators into DC power compatible with a power grid, for example, are frequently operated from a common control station or monitoring unit. The individual inverter units have a memory unit, in which a multiplicity of data items relating to operation both of the inverter unit and of the connected electricity generator can be stored. Further, parameters relating to the method of operation of the unit may also be stored. It has to be possible to call up all of these values, i.e. measured values and state values as well as parameters, in the control station. This may be done to monitor and control the power generating installation as an entity or for information purposes only. For example, it should be possible to tell from the values whether an inverter or a PV module being one of the power generators has failed, or to obtain information as to what total amount of power is currently generated.

Until now, the data relating to the individual inverter units, i.e. in particular the inverter units of PV modules, have been checked individually. This means, for example, that a high data volume must be transmitted in order to determine the instantaneous power of all the electricity generators, which not only leads to the transmitted data being highly difficult to understand but, and this is much more important, takes a lot of time in which all the data links between the monitoring units and the inverter unit are completely occupied.

In the case of a power generating installation having a plurality of electricity generators, for example PV and/or wind power installations, and a plurality of inverter units, wherein each inverter unit or appliances which are connected thereto for data purposes has or have a memory unit, wherein the memory unit records measured values relating to the power of the generator, on the one hand, and/or state values both relating to the state of the inverter unit and relating to the state of the connected power generators and/or parameters which define the method of operation of the unit, on the other hand, it is proposed that these values and parameters are stored in the memory unit in accordance with a specific organization scheme. In such an embodiment the plurality of inverter units or the appliances which are connected to them for data purposes are connected to at least one monitoring unit, wherein the monitoring unit may be in the form of a computer (for example a PC), wherein a key code is stored permanently or can be entered in the monitoring unit and correlates with the organization scheme in the memory unit of the inverter units. The key code causes the values and parameters to be read from the memory unit and the values and parameters to be displayed in the monitoring unit. In one embodiment the key code has one or more selection keys or sub-keys, by means of which access is made to the values and parameters stored in the respective inverter unit or the respective appliance. This organization scheme allows values and parameters to be checked as required.

It is advantageous in one embodiment for at least two selection keys or coding ranges, but particularly advantageously four selection keys or coding ranges, to be part of the key code. It has been found that the most frequent information situations are covered when using four selection keys.

In addition, the monitoring unit may have one or more tasks, with specific key codes resulting from the tasks. By way of example, a warning may have to be issued when a specific power level is undershot. This requires details relating to the present power level. To this end, the relevant power data are read from the memory units by means of the permanently stored keys, are processed in the monitoring unit, and the warning is issued, for example, when a specific value is reached.

It is evident from this that values may selectively be filtered out of the multiplicity of values offered by means of inputting a key code with a plurality of digits, in which the individual digits may be assigned to selection keys or sub-keys or coding ranges, and these values are then displayed by the monitoring unit. It is particularly advantageous in this case that, because the key code correlates with the organization scheme in the memory unit of the respective inverter unit, any desired number of further electricity generators, for example with corresponding inverters, can be connected even retrospectively to the power generating installation since it is possible to include new electricity generators, for example PV and/or wind power installations, in the monitoring by means of the identity of the key code with the selection keys or sub-keys, using the data stored on the basis of the same organization scheme in the memory unit. This, for example, means that it is possible in the case of a power generating installation having a plurality of PV modules and a plurality of inverter units, as well as further wind power installations with inverter units, to determine the power of the PV modules at the DC side of the inverters, only. This means that it is possible to select widely differing data items, and particularly only these data items, for display via the individual selection keys or sub-keys or coding ranges in the key code.

Present operation data of the installation may also be checked entirely or partially by means of generating corresponding key code settings in the monitoring unit. To this end, the monitoring unit may virtually automatically produce key code settings as appropriate for solving the respective problem. This problem may, for example, be displaying up-to-date information to a user. The user may either describe his information requirement directly, for example by entering a key code or clicking the subject areas of interest to him on a graphics user interface, or he can describe the information requirement indirectly in that his actions or the operating situation of the installation, or further information items, allow the monitoring unit to determine what information is required in the monitoring unit, and a key code or key code setting is generated therefrom by means of an algorithm that is stored in the monitoring unit. This means that the system may have an autonomous learning capability, to a certain extent.

When an installation only has a few inverter units, from a relative point of view, i.e. for example the inverters of a PV installation, the memory unit of one inverter unit may be in the monitoring unit. This means that the memory unit has a computer unit and a display, and to this extent acts as a master unit, to which the other inverters are subordinate or slaves.

One or more digits of the key code may be occupied by an open key. An open selection key or sub-key is a key code setting which has no or a reduced filtering effect. The result of this is as follows: As has already explained, the key code correlates with the organization scheme in the memory unit of the respective inverter unit. This means that the digits in the key code, i.e. the digits at which a selection key or sub-key can be entered, correlate directly with the organization scheme in the memory unit. This means that, for example when one digit in the key code is in a defined space which is used for holding the selection key relating to the nature of the electricity generator, then, if this space is not occupied by the selection key or sub-key, but by the open key, it is no longer possible to select that, for example, only the data from the PV power generators are determined, but that the data of all the electricity generators are determined, i.e. for example both of the PV installations and wind power installations. This means that the so-called open key does not result in any selection being made within the context of the group indicated or specified by the digit in the key code. This means that, in the extreme, when all of the digits in the key code are each occupied by an open key, all available values will be indicated and transmitted.

Various technical alternatives are feasible for the implementation. For example, a selection key or sub-key may assume a value which identifies it as being open and completely cancels out the filter effect of this key. Furthermore, values for partial cancellation of the filter effect are feasible, in the sense of a partially open key with a reduced filter effect. Furthermore, it is possible to indicate a range in which the keys to be filtered should or should not be located. Further filter options are obtained by means of bit masks or lists of values, or intervals, or algorithmic filter descriptions.

In one particularly advantageous variant, the bit-by-bit linking of the sub-key settings relating to a relatively long bit sequence can be interpreted as a binary number. A range can then be indicated for this number by means of a “from”-“to” mechanism. The indication of this range in the overall key makes it possible to cancel the filter effect for any sub-key when the filter effect of the sub-keys coded in the lower-value bits of the overall key is likewise canceled.

This implementation offers major advantages for the implementation of data storage and processing.

This is particularly true when the aim is to carry out checks on a monitoring unit in resource-limited memory units (little memory, little available computation capacities). In this case, in which partially open keys are used, the checking key which comprises a plurality of sub-keys is used as a linear numerical value. This means that the already described separate evaluation of the sub-keys a to d as individual “from”-“to” ranges is replaced by a single “from”-“to” range in the key. One advantageous feature in this case is that the combination of the responses in the memory units does not require any additional resources, since the required measured-value ranges and/or parameter ranges are already stored and available in the desired required form, i.e. the organization scheme of the checking key corresponds to the arrangement of the data to be transmitted in the memory unit. The description so far has shown how the individual values and parameters can be called up by the monitoring unit. However, it is possible to edit and to set parameters for the inverter units by the same means, as well. This means that information which results in a change to individual parameters is transmitted by means of the key code.

As already mentioned, a plurality of inverters, for example, are connected to one monitoring unit. If, however, there is a multitude of inverter units, then the data volume is much too high both for directly being handled and processed by a single monitoring unit. In this case, a plurality of intermediate data handling units are provided, in particular with the plurality of intermediate data handling units being connected to one another in a cascaded manner. This means that the processing and communication units are connected to one another on the basis of a tree structure. In this tree structure, the plurality of inverter units are combined to form groups, wherein each group in a first cascade is associated with one intermediate data handling unit, wherein the intermediate data handling units in a plurality of groups are connected to at least one superordinate intermediate data handling unit in at least one next cascade or directly to the monitoring unit. A tree structure such as this makes it possible for the measured values or parameters to be merged by the intermediate data handling units in each cascade corresponding to the selection key or sub-key and/or the open key, and to be processed by predetermined algorithms, for example by averaging, in the intermediate data handling units to form display values which are displayed on the monitoring unit at the highest cascade level. This selection of data and their merger means that the amounts of data which are transferred from one cascade level to the next cascade level in the tree structure of the intermediate data handling units can be kept relatively small. This is because the values and parameters predetermined by the key code are merged or combined in each cascade. This means that data fusion or merger is carried out in each level of the cascade, as a result of which the amount of data forwarded from one cascade level to the next higher cascade level is governed essentially only by the number of the intermediate data handling units in the respective cascade, whereas the amount of data forwarded by each intermediate data handling unit towards the next higher cascade level always remains the same. Compared to the transmission of a multiplicity of data items, in which such fusing is not carried out, the transmission speed is therefore extremely fast. In the present case, the present operation data are transmitted in the format of so-called (data) messages, with the possibility of merging individual messages to combine the content of these individual messages in one data message.

The information content does not suffer by the fusion or merger process, particularly for the end user; on the contrary, sensible preprocessing by means of merging of the values and parameters makes it possible to reduce the data to what is essential and therefore important; inter alia, this takes place by individual measured values and parameters being classified on the basis of their importance.

In one particularly advantageous embodiment, the fusion or merger includes one or more of the following algorithms: determining the minimum, the maximum, the sum total, the average, the weight of the value for averaging typically as a number or as the power of the inverter units, or the number of occurrences of a certain status of the settings of the units. In one advantageous refinement, with adjustable values, the setting range is also transmitted. The setting ranges of several data messages are merged or fused into one or more of the following values: maximum upper limit which can be set, minimum upper limit which can be set, as well as the minimum and maximum for the lower limit and for the currently set values. Even in the case of large installations, this quickly allows a clear overview to be obtained of the settings, which may differ, and also of adjustable parameter values.

Before the actual merging process may take place, the measured values or parameters may need to be normalized. This is the case whenever, for example, inverters of different power classes are used in one installation. The inverters may in each case provide a specific power, the absolute values of which differ, but which are comparable with respect to the respective maximum power level. This means that, for example, if one inverter has a rating of 1000 W but the other inverter has a rating of 15 000 W, because its power class is not the same as that of the first inverter, but both inverters are operating at 99% of the power limit, then a normalization process is carried out to produce percentages since otherwise sensible merging would be impossible if one wishes to know how close the installation is operating to its power limit.

The keys, measured values and further stipulations relating to the particular embodiment quoted in the following example have had their scope reduced in order to assist understanding, and do not represent any restriction to the scope of the present description.

### a) Importance of the Value (3 Bits, Maximum 8 Options):

First of all, it is assumed that the individual parameters and measured values are weighted differently. Thus, there are values whose weighting is high, further values with a medium weighting, and further values whose weighting is low with respect to their significance, and in particular with respect to their validity and the frequency with which they are checked. The definition of the levels relating to these values is therefore predetermined.

The important factor in this case is that the individual values of the different levels are related to one another alternatively, i.e. the values are all rejected only when the key associated with each level is indicated. This means that the sum of the values of all three keys results in the output of all the values.

1: High level, few values

2: Medium: approximately ¾ of the values

3: All the remaining values

The totality of all the values (parameters and measured values) for a system will be described by the sum (1)+(2)+(3).

### b) Functional Grouping (5 Bits, Maximum 32 Options):

Each unit in an overall system supports at least one of these function groups:

1 Unit status (Stat)

### 2 Appliance (Dev)

3 DC side (DC)
4 Network values (Grid)

### 5 Meteorology (Met)

6 Grid guard (GG, configuration of country-specific feed guidelines)
7 Theft protection (TP)
8 Memory media (Stor)

### 9 Generator (Gen)

### 10 Battery (Batt)

11 Limit value objects (Lim)
12 Decoupling protection (Coup)
[13-32 spare]

The abovementioned 12 groupings, which are listed merely by way of example, are represented partially as parameters, partially as measured values, but partially also as parameters and measured values. In this case, measured values are those values which can be exclusively read. Parameters are those values which can be read and written, i.e. the settings of which can also be varied. In this context, by way of example, the following values are measured values on the DC side, i.e. for example voltage and current, meteorology values, such as solar radiation, ambient temperature, wind direction. In detail, the expression unit status means, for example, whether the unit is or is not serviceable; the parameters which may be associated with an appliance in 2 mean, for example, scalings, switch-off limits, control parameters. The expression memory means whether the unit is provided with memory equipment and in consequence is able to store data, and how full the memory is. The term “limit value object” describes a data object which transports information on how closely a unit is operating to a limit of its functionality. For example, the power supplier defines limits for the network voltage. If the unit finds that these limits have been reached or overshot, then it must cease operation. A similar operation applies to physical limits for the unit, for example the maximum power which can be emitted. If this is reached, it may no longer be possible to completely convert the power of the generator. Alternatively, for example, the maximum voltage at the DC input. If this is exceeded, the unit may be damaged.

In one advantageous refinement, the limit value objects are defined such that they assume the value +100% on reaching an upper limit, and/or assume the value −100% on reaching a lower limit.

In one advantageous variant, the limit value objects assume values which represent the percentage value of the respective measured value with respect to its critical limit. An input voltage of ½ of the permissible maximum would therefore result in a limit value object of 50%.

In one alternative variant, some values are scaled such that the percentage provides the user with the separation sensed from a problem situation.

### −50%-+50%=all OK

50%-90%=installation loaded
90%-99% (also -)=installation soon critical
100%=installation operation critical
100%-200%=installation operation restricted/ceased, since one parameter is outside the permissible range.

Limit value objects have the advantage that information from different units can be combined, which was previously not combined in a worthwhile form. For example, the permissible DC voltage at the input is dependent on the unit. If the DC voltage is combined on the basis of min., max., mean value rules then this does not result in any information which can be interpreted in a worthwhile form by the user for different units which, for example, may also have differently structured generators. Surprisingly, this is not the case when the DC voltage is formulated as a limit value object, i.e. by “normalization”, as a result of which the user can quickly be provided with a good overview assessment as to how far his installation is away from problem situations, in which case the limit value objects need be merged only on the basis of the already mentioned merging rules min., max., and mean value. In this case as well, the values may need to be normalized, as described above.

### c) Sequential Number of the Value (8 Bits, Maximum 256 Options):

Each measured value or parameter from (b) of a group is provided with a sequential number in order to uniquely indicate the measured value or parameter within this group. This means that all the measured values or parameters in a group have the identical number on all units, i.e. for example the current on the network side of each unit is provided with the same number. The distinction for example with regard to wind or PV is drawn by (d), the appliance class.

This means that, under (c), the values and parameters are numbered sequentially as a sequential number and are associated under (a) with the classification high level, medium level and low level. This means that the functional groupings under (b) and the appliance class are therefore on the one hand characterized by the sub-key (a) and are on the other hand characterized by a sequential association of numbers (c). It is immediately clear from this that, by means of the question of the importance of the value, the sequential number with respect to the functional grouping as well as the respective appliance class, the individual values can be addressed by an appropriate key code.

Each parameter in a group (b) is provided with a sequential number for unique indication within this group.

### d) Appliance Class (8 Bits, Maximum 256 Options):

Each unit belongs to only one appliance class:

1 PV (solar inverter)
2 Wind (wind energy installation inverter)
3 Water (hydroelectric power station inverter)
4 Block heating power station
5 Fuel cell (generates electricity from a hydrogen reservoir)
6 Generators (rotating power generators, for example diesel sets)
7 Battery (battery chargers, or else battery inverter units)
8 Electrolyzers (hydrogen generators)
9 Smart load (controlled load)
10 Other loads
11 Solar tracker systems (solar panel tracking systems)
12 Communication units/gateways

The appliance class can be subdivided into three types of appliances, to be precise on the one hand power generators, power consumers and so-called appliances which are connected for data purposes to such power generators and consumers. One uniting feature of the power consumers and power generators is that they each have an inverter unit. In this case, the following power generators may be provided in one power generating installation:

### 1. PV

### 2. Wind

### 3. Water

4. Block heating power station
5. Fuel cell
6. Generators (direct current, polyphase, alternating current)

### 7. Battery

These power generators have at least one inverter unit, when direct current is generated and fed into an AC power grid.

Furthermore, there are loads, for example so-called electrolyzers. An electrolyzer is an installation for hydrogen generation by means of electrical power (electrolysis). Furthermore, there are in fact also so-called solar tracker systems (solar panels which track the position of the sun) and, overall, communication units/gateways which are connected for data purposes to the individual power generators or loads, as has already been explained elsewhere. It should also be possible to check these units using the same data mechanisms.

The checking key is composed of these four parts:

“abcd”

A checking unit can now generate a “from”-“to” range for checking for each sub-key.

a: from 0 to 7 (3 bits)
b: from 0 to 31 (5 bits)
c: from 0 to 255 (8 bits)
d: from 0 to 255 (8 bits)

The check is sent without any specific appliance address or addresses as a so-called “broadcast” (all units are addressed) into the communication network. All units which are ready to receive evaluate this request or selection key. All the measured values and parameters in the units have the sub-keys “a”, “b” and “c” stored locally as attributes. The sub-key “d” is obtained from the type of appliance.

If the requested key now matches one or more of the locally available measured values or parameters, then the request is acted on by the relevant unit.

Read request: the desired value or values is or are sent from the unit to the requester (for example the processing and communication unit);

Write request: the value or values transmitted is or are evaluated by the unit (for example accepted as a modified parameter).

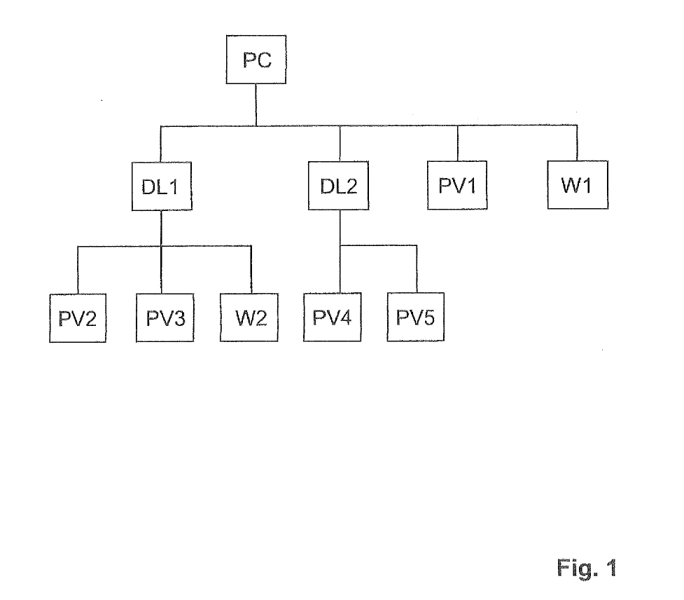

Referring now in greater detail to the drawings, FIG. 1 shows an example of one feasible installation topology in cascaded form. At the top of the cascade there is a PC used as a monitoring unit. On the next level of the cascade there are two data loggers DL1 and DL2, which are used as intermediate data handling units here, plus one inverter unit PV1 to which photovoltaic power generators are connected and one inverter unit W1 to which a wind power generator is connected. All units of this second level of the cascade are directly connected to the PC. The third level of the cascade includes two inverter units PV1 and PV2 plus one inverter unit W2 connected to DL1 plus two inverter units PV4 and PV5 connected to DL2. The data links between the units in the cascade branch from the monitoring unit towards the inverter unit on the lowest level. In total the installation according to FIG. 1 includes one PC as a monitoring unit, two data loggers DL as intermediate data handling units, and 5 inverter units PV connected to photovoltaic power generators plus 2 inverter units W connected to wind power generators.

### Example 1

The monitoring unit PC wishes to be supplied from the installation only with

P-DC

P-AC

energy meter

from PV, wind (W) or hydroelectric power stations (HP). A key code setting for the corresponding generic request is therefore generated as follows:

unit of the PV, wind or water type (d)

index from 1.4 (c)

group (b) DC side or network side (AC)

only high-level values (a)

With respect to (c), it can be said that this generic request or selection key must be stated in such a way that it comprises at least those values which are intended to be displayed. (c) must run from 1 to 2 as a minimum. There is no upper limit since all that is displayed is that which is identified under (b) by the corresponding level under (a).

Key code settings of the generic request

| a | | b | | c | | d | |
|---|---|---|---|---|---|---|---|
| from | to | from | to | from | to | from | to |
| 1 | 1 | 3 | 4 | 1 | 4 | 1 | 3 |

Only HP, PV and W exist as appliance classes in the system.

HP: this will be addressed by the sub-key (d) but does not respond because there are no units of the “water” (HP) type in this system and, in consequence, no response can be generated either, and therefore cannot respond.

PV (photovoltaic): all PV (1.5) are addressed by the sub-key (d)
has the values P-DC, P-AC and energy meter with importance (a)=1. W (wind): all W (1 and 2) are addressed by the sub-key (d)
has the values P-DC, P-AC and energy meter with importance (a)=1.

All PV and W units respond to the generic request with in each case three response messages (in each case one for P-DC, P-AC and energy meter). In addition to the respective measured value, each response message also includes, inter alia, the associated unique key from (c) and (b), and the appliance address.

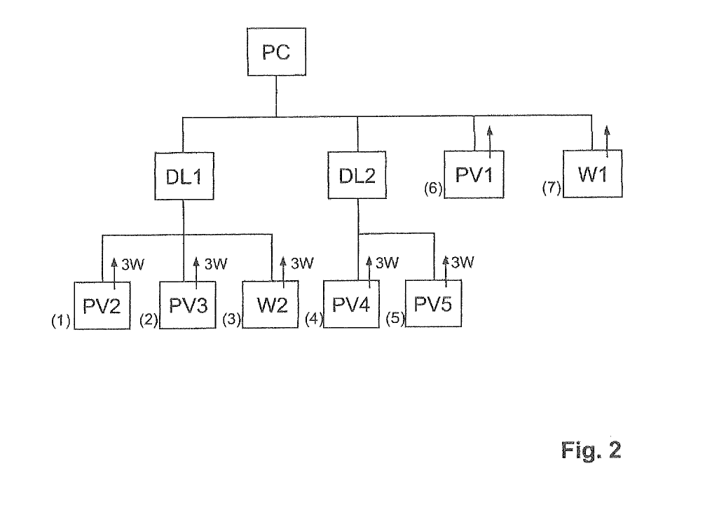

### Merging Process (see FIG. 2):

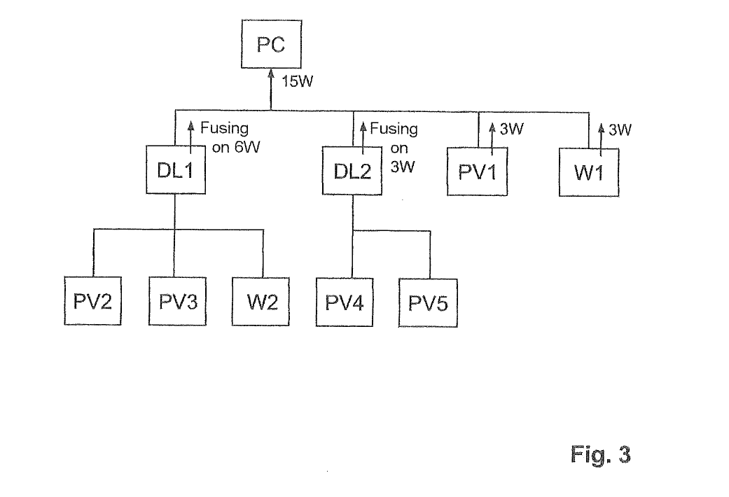

1. All units selected by means of the key generate response messages. A total of 7×3=21 messages are sent by the units PV-n and W-n (FIG. 2). The number “3” results from PDC, PAC, energy (meter). The number “7” results from the total number of units. In this case, the content of individual messages may in principle also always be combined to form one message.
2. Data loggers as intermediate data handling units carry out merging as intermediate data handling units, i.e. values with the same selection or checking key are combined. Each intermediate data handling unit and each PV and W will have a memory unit organized in the same way (FIG. 3).

Therefore, of the original 21 messages, only 5×3=15 messages arrive at “PC”. The number 5 results from W1, PV1, DL2 and DL1, where DL1 reflects the merged data from PV2 and PV3 as well as from W2. According to the invention, PV and W are not combined by DL1, in order not to reduce the value of the information by combination of sources with different contents. The data logger (DL1) identifies this because each value which arrives at the data logger also includes details relating to the appliance class W or PV.

The merging process produces the following information from the individual values:
P-DC merged produces minimum, maximum, mean value and weighting (number of units)
P-AC merged produces minimum, maximum, mean value and weighting (number of units)
energy meter merged produces minimum, maximum, sum and weighting (number of units).

The monitoring unit PC also itself carries out merging and reduces the received 12 messages to 6, since the keys of each of the three measured values of all the PV units are the same, and those of all the W units are the same.

### Example 2

The monitoring unit PC may check all the values of PV units from the group “DC side” (b=3) from the installation having the importance 1 and 2.

A generic request is therefore generated as follows:

unit of the PV type (d)

index from 1.12 (c) (randomly chosen “open key”, at least 1-4 (c))

group (b) DC side only

high-level values AND medium-priority values (a)

Key code settings of the generic request

| a | | b | | c | | d | |
|---|---|---|---|---|---|---|---|
| from | to | from | to | from | to | from | to |
| 1 | 2 | 3 | 3 | 1 | 12 | 1 | 1 |

In this case

P-DC

U-DC

I-DC

U-DC-Max

are supplied by PV units since only the first four measured values exist in the group (b) DC side (sequential number c used only from 1.4).

The only appliance classes in the system are HP, PV and W.
HP: is not addressed by the sub-key (d), and does not respond.
PV: all PV (1.5) are addressed by the sub-key (d)
has the values P-DC, U-DC, I-DC and U-DC-Max with importance (a)=2.
W: is not addressed by the (d) sub-key, and does not respond.

All PV units respond to the request with in each case four response messages (in each case one for P-DC, U-DC, I-DC and U-DC-Max). In addition to the respective measured value, each response message also contains, inter alia, the associated unique key and the appliance address.

Merging Process:

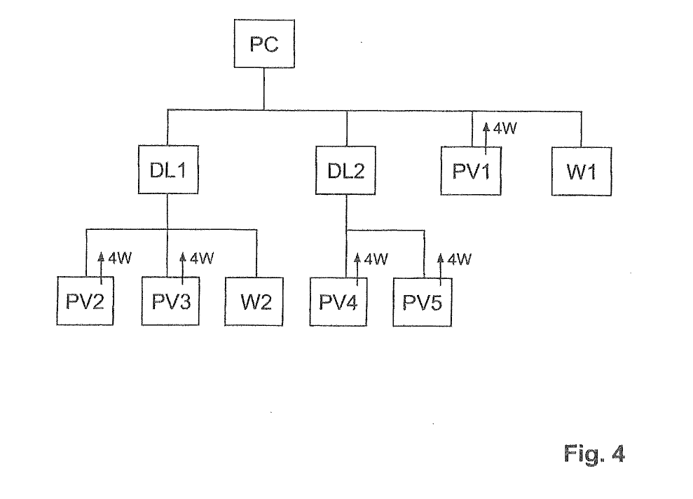

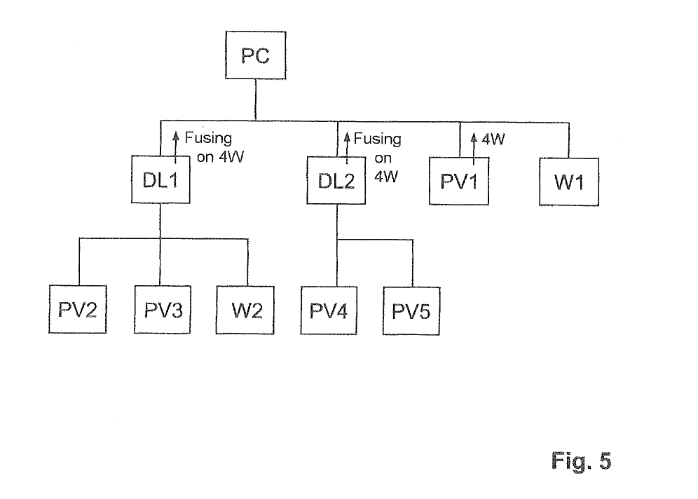

1. All units selected by means of the key generate response messages. A total of 5×4=20 messages are sent by all PV units (FIG. 4).
2. Data loggers carry out merging, i.e. values with the same key are combined (FIG. 5).

Only 12 of the original 20 messages therefore arrive at “PC”.

The merging process produces the following information from the individual values:
P-DC merged produces minimum, maximum, mean value and weighting (number of units)
U-DC merged produces minimum, maximum, mean value and weighting (number of units)
I-DC merged produces minimum, maximum, mean value and weighting (number of units)
U-DC-Max merged produces minimum, maximum, mean value and weighting (number of units).

The monitoring unit PC also itself carries out merging and reduces the received 12 messages to four, since the keys of the four measured values of all units are the same.

The following examples 3 and 4 are intended to explain the merging principle with a partially open key. The data combination with a partially open key is represented with respect to the memory units, as a resource-conserving measure. In this case, the advantage of data combination in a manner that conserves memory unit resources is obtained at the expense of a less effective filter effect. This reduced filter effect may, however, be compensated for by skillful arrangement of the measured values and parameters within the organization scheme, by designing the organization scheme such that the data checks to be expected most frequently produce the same result with the partially open keys in this case as the use with disjunct sub-keys.

Fundamental rules for the use of partially open keys with the sub-keys a to d are:

Rule 1: only one sub-key can be used with a restricting “from”-“to” range;
Rule 2: the lower-value sub-keys (a>b>c>d) must then be kept completely open; the higher-value sub-keys must not define a range.

### Example 3

The monitoring unit PC wants to be supplied from the installation with a topology as shown in FIG. 1 only with

P-DC

P-AC

energy meter

from all available units (“from all” is the convention for rule 2).

A generic request is therefore generated as follows:
unit as open key (d=0 to 255, i.e. all)
index from 1.4 (c, complies with rule 1)
group (b) AC side (“from”/“to” is identical, therefore uniquely defined, complies with rule 1)
only high-level values (a, “from”/“to” is identical, therefore uniquely defined, complies with rule 1)

This means that the hierarchy relating to the generic request referred to in the following is configured such that it rises to the left.

Key Code Settings of the Generic Request

| a | | b | | c | | d | |
|---|---|---|---|---|---|---|---|
| from | to | from | to | from | to | from | to |
| 1 | 1 | 4 | 4 | 1 | 4 | 0 | 255 |

The only appliance classes in the system are DL, PV and W.

DL: is addressed by the (d) sub-key and responds, but has no values which correspond to the higher-value keys a to c.
PV: all PV (1.5) are addressed by the (d) sub-key
have the values P-AC and energy meter with importance (a)=1;
   W: all W (1 and 2) are addressed by the (d) sub-key
have the values P-AC and energy meter with importance (a)=1.

There are no further appliance types in this system and no further appliance types can in consequence respond either. If there were any such types, they would be addressed by the open sub-key of appliance class (d).

All PV and W units respond to the request with in each case two response messages (in each case one for P-AC and energy meter). In addition to the respective measured value, each response message inter alia also contains the associated unique key and the appliance address, and also the appliance class PV or W, which allows the classification in the merging process.

All units selected by means of the key generate response messages. A total of 7×2=14 messages are sent by the units PV-n and W-n. The principle is illustrated in FIG. 2; however, there are only two values (PAC and power) in example 3, rather than three values.

The data loggers carry out merging, i.e. values with the same key are combined. Although the request key has opened the sub-key appliance class, the responses contain a unique key, however. Only values with an identical key are combined, which means that values of PV and W are not combined, because—as already stated—the values are characterized by the respective appliance class PV or W. Reference is made to FIG. 2 and FIG. 3 with regard to the merging process.

Only 10 of the original 14 messages therefore arrive at the monitoring unit (PC).

The merging process produces the following information from the individual values:
P-AC merged produces minimum, maximum, mean value and weighting (number of units)
energy meter merged produces minimum, maximum, sum and weighting (number of units)

The monitoring unit (for example a PC) itself also carries out merging and reduces the received 10 messages to 4, since the keys of the in each case two measured values of all PV units are the same, and those of all W units are the same.

### Example 4

### See the Table of Measured Values at the End of this Description

The monitoring unit PC is intended to check from the installation all values of all units from the group “DC side” (b=3) and “AC side” (b=4), with the importance 2.

A checking key is therefore generated as follows:

all units (d=0 . . . 255)

all indices (c=0 . . . 255)

group: only AC and DC side (b=3 to 4)

medium-importance values (a=2)

Key Code Settings of the Generic Request

| a | | b | | c | | d | |
|---|---|---|---|---|---|---|---|
| from | to | from | to | from | to | from | to |
| 2 | 2 | 3 | 4 | 0 | 255 | 0 | 255 |

In this case, only

P-DC

U-DC

I-DC

U-DC-Max

are produced by all units, since only the first four measured values exist with importance 2 in the group (b) DC side (sequential number c used only from 1.4). In the group AC, there are no values with importance 2 for any of the units present.

The only appliance classes in the system are DL, PV and W.

DL: although addressed by the (d) sub-key, it does not itself have any values which correspond to the higher-value sub-keys a to c, and does not respond with its own data
PV: all PV (1.5) are addressed by the sub-key (d)
have the values P-DC, U-DC, I-DC and U-DC-Max with importance (a)=2.
   W: all W are addressed by the sub-key (d)
have the values P-DC, U-DC, I-DC and U-DC-Max with importance (a)=2.

All PV and W units respond to the request with in each case four response messages (in each case one for P-DC, U-DC, I-DC and U-DC-Max). In addition to the respective measured value, each response message also contains, inter alia, the associated unique key and the appliance address, in order to fuse only those values from units in the same appliance classes.

Merging Process:

1. All units selected by means of the key generate response messages. A total of 7×4=28 messages are sent by all the PV units. Reference is made to FIG. 2 and FIG. 3 for the merging principle.
2. The data loggers fuse values and parameters, i.e. values with the same key are combined.

Only 16 messages of the original 28 therefore arrive at “PC”. The merging principle is shown in FIG. 2 and FIG. 3.

The merging process produces the following information from the individual values:
P-DC merged produces minimum, maximum, mean value and weighting (number of units)
U-DC merged produces minimum, maximum, mean value and weighting (number of units)
I-DC merged produces minimum, maximum, mean value and weighting (number of units)
U-DC-Max merged produces minimum, maximum, mean value and weighting (number of units)

The monitoring unit PC itself also carries out merging, and reduces the received 16 messages to eight, since the keys of the four measured values differ only in the appliance class (d) W and PV.

Table of Measured Values:

Basic layout of the organization of measured values in PV inverter units for the selection keys or sub-keys (b) and (c):
Blank fields indicate that the measured value is not available at the unit.
**: importance 1, *: importance 2, no *: importance 3 (=level 1, 2, 3=sub-key a)

| | b | | | | | | | | | | |
|---|---|---|---|---|---|---|---|---|---|---|---|
| c | 1 Stat | 2 Dev | 3 DC | 4 Grid | 5 Met. | 6 GG | 7 TP | 8 Stor | 9 Gen | 10 Batt | 11 Lim |
| 1 | Health** | Rᵢₛₒ | P_{DC}** | Power** | | | | SD | | | |
| 2 | Event** | hₜₒₜₐₗ | U_{DC}* | P_{AC}** | | | | | | | |
| 3 | | h_{grid} | I_{DC}* | U_{AC} | | | | | | | |
| 4 | | Temp | U_{DCmax}* | I_{AC} | | | | | | | |
| 5 | | t_{fan} | | Freq | | | | | | | |
| 6 | | | | Q_{AC} | | | | | | | |

Basic layout of the organization of the measured values in W units for the sub-keys (b) and (c):

| | b | | | | | | | | | | |
|---|---|---|---|---|---|---|---|---|---|---|---|
| c | 1 Stat | 2 Dev | 3 DC | 4 Grid | 5 Met. | 6 GG | 7 TP | 8 Stor | 9 Gen | 10 Batt | 11 Lim |
| 1 | Health** | | P_{DC}** | Power** | | | | | | | |
| 2 | Event** | hₜₒₜₐₗ | U_{DC}* | P_{AC}** | | | | | | | |
| 3 | | h_{grid} | I_{DC}* | U_{AC} | | | | | | | |
| 4 | | Temp | U_{DCmax}* | I_{AC} | | | | | | | |
| 5 | | | | Freq | | | | | | | |

Many variations and modifications may be made to the preferred embodiments of the invention without departing substantially from the spirit and principles of the invention. All such modifications and variations are intended to be included herein within the scope of the present invention, as defined by the following claims.

1. A method of forwarding operation data related to a present operation of a plurality of inverter units to a monitoring unit, the inverter units feeding electric power from power generators into a power grid, the method comprising:
connecting the inverter units and a plurality of intermediate data handling units to the monitoring unit in a communication network of a logical tree architecture, the tree architecture branching towards the inverter units, and several inverter units being connected to at least one intermediate unit;
forwarding operation data from each inverter unit to that intermediate data handling unit to which the inverter unit is connected;
in each intermediate unit connected between respective multiple inverter units from which the operation data are forwarded and the monitoring unit, merging operation data of a same type forwarded from the inverter units connected to the respective intermediate unit to reduce an associated data volume, and
from each intermediate unit towards the monitoring unit, forwarding the merged operation data.

2. The method of claim 1, wherein the inverter units are spatially distributed.

3. The method of claim 2, wherein the intermediate units are arranged spatially closer to the inverter units than to the monitoring units.

4. The method of claim 1, wherein the merged operation data include at least one piece of information selected from a group of pieces of information comprising:
a number of the inverter units from which the operation data contributing to the merged operation data have been forwarded;
an overall range of values of the same type included in the operation data contributing to the merged operation data;
an average of values of the same type included in the operation data contributing to the merged operation data;
a standard deviation of values of the same type included in the operation data contributing to the merged operation data from their average;
a median of values of the same type included in the operation data contributing to the merged operation data;
a sum total of values of the same type included in the operation data contributing to the merged operation data;
a number of identical discrete values of the same type included in the operation data contributing to the merged operation data;
a code indicating the type of the operation data contributing to the merged operation data; and
a kind of the inverter units from which the operation data contributing to the merged operation data have been forwarded.

5. The method of claim 1, wherein the operation data have a same format as the merged operation data.

6. The method of claim 1, wherein forwarding the operation data towards the monitoring unit is initiated by a generic request issued by the monitoring unit, the generic request indicating that every unit in the communication network which is able to forward the requested operation data should do so.

7. The method of claim 1, wherein the operation data are forwarded from one intermediate data handling unit to a next intermediate data handling unit in the communication network towards the monitoring unit, due to a subscription of the operation data by the next intermediate data handling unit.

8. The method of claim 1, further comprising power generators coupled to respective ones of the plurality of inverter units to form a communication network, wherein operation data from the power generators are merged in the respective inverter units and any intermediate unit upon being forwarded towards the monitoring unit.

9. The method of claim 1, characterized by the further step of connecting at least one further unit to the communication network.

10. The method of claim 9, wherein the further unit is a further monitoring unit.

11. The method of claim 6, wherein the generic request is coded in a key code having a plurality of coding ranges each defining one aspect of the operation data in variable detail depending on an actual setting of the key code in the respective coding range.

12. The method of claim 11, wherein the key code has at least one setting resulting in operation data being forwarded towards the monitoring unit without being merged in any intermediate unit.

13. The method of claim 1, wherein at least one intermediate unit is spatially arranged at and comprises one of the plurality of inverter units.

14. The method of claim 11, wherein the key code defines the operation data of the same type to be merged.

15. The method of claim 14, wherein the key code further defines rules according to which the operation data of the same type are merged.

16. The method of claim 11, wherein the key code has at least three different coding ranges defining a level of importance of the requested operation data, a general kind of the requested operation data, and a kind of the units from which the operation data are requested.

17. The method of claim 16, wherein settings in the key code ranges each include settings corresponding to no selection, a limited selection, and a selection of a single kind.

18. A data handling unit configured to forward operation data related to a present operation of a plurality of inverter units to a monitoring unit, the data handling unit comprising:
an upward connection port configured to receive requests for values from an upper unit and for forwarding requested operation data to the upper unit, and
a downward connection port configured to send requests for values to a plurality of lower units associated therewith and configured to receive the requested operation data from the lower units,
wherein the data handling unit, upon receiving a generic request from the upper unit that does not request operation data available in the data handling unit, forwards the generic request to all of the plurality of lower units associated therewith, merges the operation data received in response to the generic request from the lower units to reduce an associated data volume, and forwards the merged operation data to the upper unit.

19. The data handling unit of claim 18, wherein the forwarded merged operation data have a same format as the received operation data.

20. A data protocol suitable for requesting and forwarding operation data related to the present operation of a plurality of inverter units by and to a monitoring unit, the inverter units feeding electric power from power generators into a power grid, the data protocol comprising:
a generic request issued by the monitoring unit,
the generic request being coded in a key code having a plurality of coding ranges each defining one aspect of the operation data in variable detail depending on an actual setting of the key code in the respective coding range, and
the generic request indicating that every unit that is able to forward the requested operation data should do so; and
and operation data forwarded by the inverter units in response to the generic request,
the operation data having a format enabling a merge of operation data of the same type included in the operation data forwarded by the multitude of inverter units without changing the format.

21. The data protocol of claim 20, wherein the key code defines the operation data of the same type to be merged.

22. The data protocol of claim 21, wherein the key code defines rules according to which the operation data of the same type are merged.

23. The data protocol of claim 20, wherein the key code has at least three different coding ranges defining a level of importance of the requested operation data, a general kind of the requested operation data, and a kind of the units from which the operation data are requested.

24. The data protocol of claim 23, wherein settings in the key code ranges each include settings corresponding to no selection, a limited selection, and a selection of a single kind.
